(19) United States
(12) Patent Application Publication
(10) Pub. No.: US 2004/0143848 A1
(43) Pub. Date: Jul. 22, 2004

(54) Method of organizing and playing back multimedia files stored in a data storage media and a data storage media stored with such multimedia files

(76) Inventors: Kwok Ying Kerri Yu, Hong Kong (HK); Chi Ming Tony Chung, Hong Kong (CN)

Correspondence Address: SMITH-HILL AND BEDELL, 12670 N W BARNES ROAD, SUITE 104, PORTLAND, OR, 97229

(21) Appl. No.: 10/346,936

(22) Filed: Jan. 17, 2003

(51) Int. Cl. H04N 7/173

(52) U.S. Cl. 725/88; 725/145

(57) ABSTRACT

A method of organizing and playing back at least a first and a second movie stored in a data storage media is disclosed, wherein the movies are stored in the data storage media each in the form of a number of self-executable multimedia files, and at least one executable multimedia file of the first movie includes machine-readable control information which, when read, directs an executable multimedia file of the second movie to be next executed.

This invention relates to a method of organizing and playing back a number of multimedia files, e.g. digital audio and visual files, stored in a data storage media, e.g. video compact discs, digital video discs, hard discs, and servers via the Internet, and a data storage media stored with such multimedia files.

### BACKGROUND OF THE INVENTION

Traditional videotape cassette recorders (VCR), video compact disc (VCD) players, video disc or laser disc (LD) players playback the pre-recorded video contents sequentially with respect to time. There are some digital video disc (DVD) players which can playback a complete movie, with different languages and/or different pre-recorded endings of the movie also recorded in the same disc, to be selected by the spectator as desired. Such conventional playback devices usually include a very simple playback control interface, allowing Fast Forward (FF), Fast Rewind (REW), Playback/Pause and Stop functions. The content producer (i.e. the producer of the recorded VCD or LD) has the absolute control of the theme of the movie and the spectator has no way to participate in the progress of the movie, short of swapping the tape or disc for another one.

By operating on such buttons as “PLAY/PAUSE”, “FAST FORWARD”, “FAST REWIND” and “STOP”, a user can operate conventional videotape cassette recorders (VCR) to play video content in a video cassette tape in sequential order. As images are recorded in a reel of film, as shown in FIG. 1A, sequential playing is the only way to playback the video content in the cassette tape. Random access of the video content is almost impossible.

Even with video compact discs (VCD), video disc and laser disc (LD), for which the video contents are stored in the discs in digital format which allow random access, the same playback control algorithm is still employed, as the users have become accustomed to this manner of operation. Although it is more versatile to playback VCD or LD instead on computers, one has to manipulate the mouse by pointing and clicking, which is not all that simple to people not used to operating computers.

A movie, say Movie ‘X’, may be schematically represented as in FIG. 1B. The movie ‘X’ includes a total of seven themes, namely Theme 1 to Theme 7, each corresponding to a clip file stored in a data storage media, e.g. a VCD, video disc, laser disc, hard disk in a local computer, or hard disk of a server computer accessible through the Internet. This movie ‘X’ has three actors, namely Principal Actor ‘P’, Associate Actor ‘Q’ and Associate Actor ‘R’, each appearing in at least one of the seven themes. For example, in the “Development” Phase of the movie, Theme 4 involves the Principal Actor ‘P’ in the leading role and the Associate Actor ‘R’ in the supporting role. In the prior art arrangement, a spectator can only go along watching the movie as it develops from the ‘Beginning’ Phase, through the “Development” Phase, until it ends at the “Ending” Phase, all at the strict control of the content producer.

It is thus an object of the present invention to provide a method of organizing and playing back a number of multimedia files stored in a data storage media and a data storage media stored with such multimedia files in which the aforesaid shortcomings are mitigated, or at least to provide a useful alternative to the public.

### SUMMARY OF THE INVENTION

According to a first aspect of the present invention, there is provided a method of organizing at least a first movie and a second movie stored in a data storage media, wherein each said movie is stored in said data storage media in the form of a plurality of executable multimedia files, and wherein at least one executable multimedia file of said first movie includes machine-readable control information which, when read, directs an executable multimedia file of said second movie to be next executed.

According to a second aspect of the present invention, there is provided a method of playing back at least part of a first movie and at least part of a second movie stored in a data storage media, wherein each said movie is stored in said data storage media in the form of a plurality of executable multimedia files, including playing back at least one executable multimedia file of said first movie, reading control information of said at least one multimedia file of said first movie, and playing back at least one executable multimedia file of said second movie.

According to a third aspect of the present invention, there is provided a data storage media stored with at least a first movie and a second movie each in the form of a respective plurality of executable multimedia files, wherein at least one executable multimedia file of said first movie includes machine-readable control information which, upon reading, directs an executable multimedia file of said second movie to be next executed.

### BRIEF DESCRIPTION OF THE DRAWINGS

Preferred embodiments of the present invention will now be described, by way of examples only, with reference to the accompanying drawings, in which:

FIG. 1A shows schematically the arrangement of various frames of pictures in a reel of film, according to a prior art arrangement;

FIG. 1B shows schematically the sequence of running of themes in an exemplary movie according to a prior art arrangement;

FIG. 2 shows schematically a number of movies which may be organized, stored and played back according to the present invention;

FIG. 3 shows schematically the organization of a number of multimedia files forming a movie, according to the present invention;

FIG. 4 shows schematically the organization of a number of movies, each consisting of a number of multimedia files, according to one embodiment of the present invention; and

FIG. 5 shows schematically the organization of a number of movies, each consisting of a number of multimedia files, according to a further embodiment of the present invention.

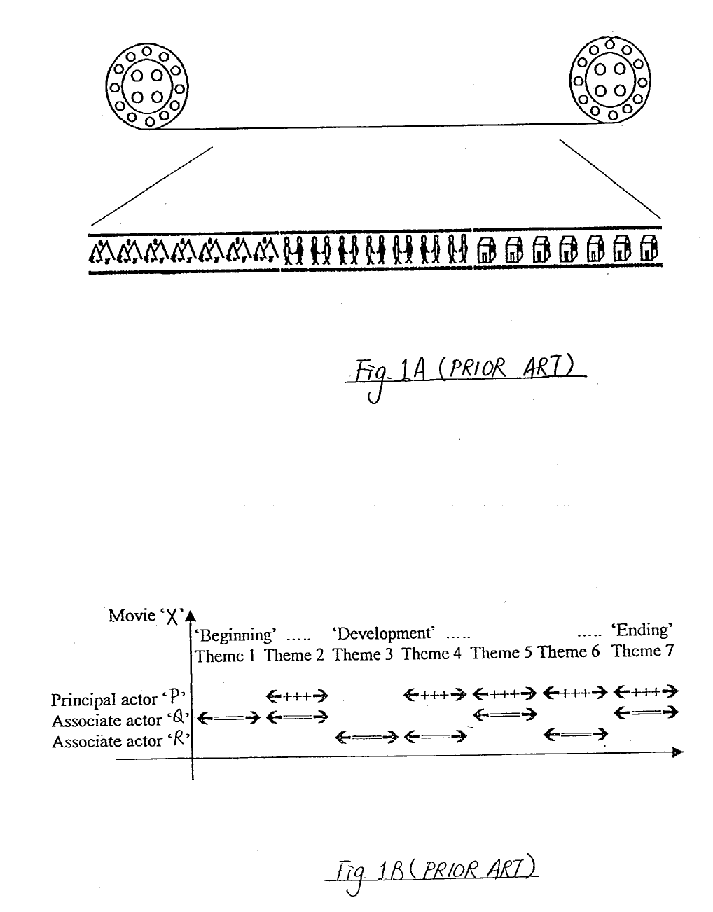

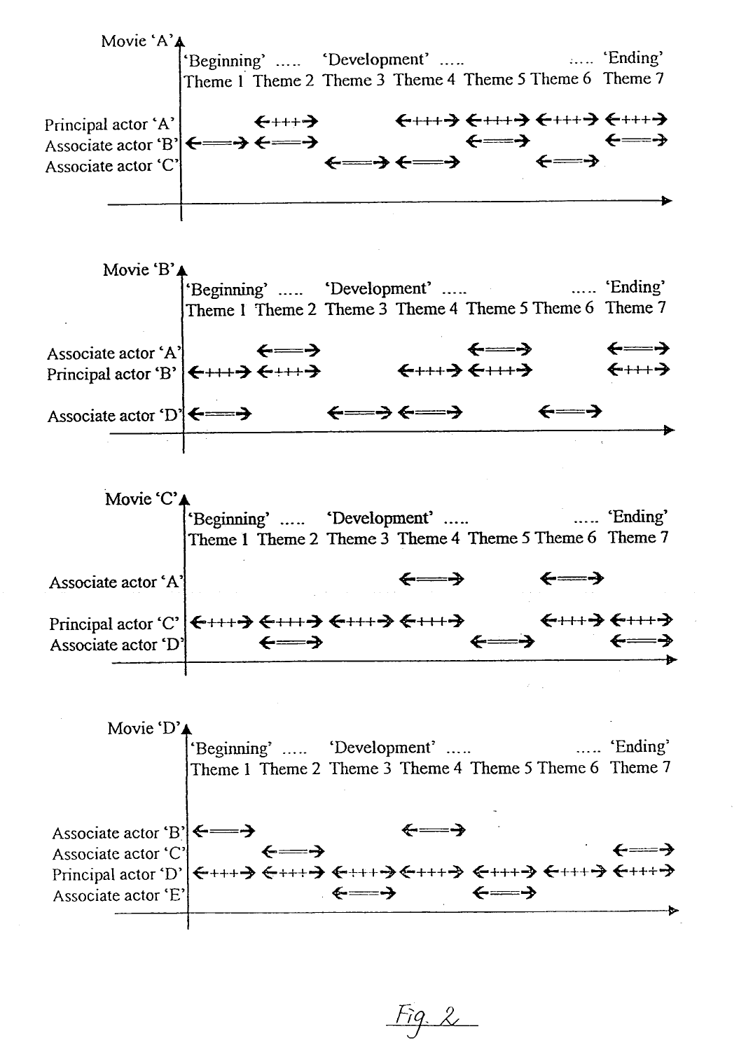

### DETAILED DESCRIPTION OF THE PREFERRED EMBODIMENTS

FIG. 2 shows schematically a number of movies which can be organized, stored and played back according to the present invention. A total of four movies, namely Movie ‘A’, Movie ‘B’, Movie ‘C’ and Movie ‘D’, are schematically shown in FIG. 2. Each movie has a principal actor and a number of associate actors. Let us assume a spectator watches Movie ‘A’, in which Principle Actor ‘A’ is in the leading role and Associate Actors ‘B’ and ‘C’ are in the supporting role. When Movie ‘A’ is played back to Theme 5, if the spectator finds that Associate Actor ‘B’ is more interesting, the he/she may, in accordance with the present invention, switch or branch to Theme 5 of Movie ‘B’. Once such a switching or branching is effected, the spectator can either go back to the earlier part of Movie ‘B’, by operating a rewind “REW” key/button to view more about the history of Actor ‘B’, or operating a “PLAY” key/button to continue watching the Movie ‘B’ from then on. Similarly, whilst viewing Theme 4 of Movie ‘C’, in which Principal Actor ‘C’ and Associate Actor ‘A’ are acting, the spectator may switch or branch to Theme 4 of the Movie ‘A’, to view, from then on, Movie ‘A’. It can thus be seen that the present invention allows linking up of a number of movies, thus forming a network of movies, in which a spectator may “travel” as he/she wishes. In particular, the movies are arranged in a tree-like hierarchical structure, hereafter called “Video Tree”, to be further discussed below.

In the present invention, a movie is truncated into a number of executable scenes, each not exceeding a pre-determined period of playback time, e.g. 10 seconds. Each scene contains contents with the same or similar background. The contents in each scene are combined with control header information to format into a clip file. The control information defines the direction to branch in the Video Tree. In particular, such special control header information in each formatted clip file contains all the information about how a film is to go, whether one continues playing the current film or branch to another film. Pictures or contents within the same clip file could be randomly accessed for the purpose of easier and quicker response to fast forward and fast backward operation.

A clip file is basically a computer file with, e.g. conventional DOS formatting structure, i.e. with file name and file extension. Other suitable formats as defined by the architecture may, of course, instead be adopted. A clip file consists of the header, video and/or audio contents, video compression method, ways to control and link/cross-link information, etc. Clip files may be stand-alone self-executable for the purpose of self-running or executable by a custom-made monitor program. For DOS format, a file supports an 8-character file name and a 3-character file extension. Although nowadays Windows® file format can support long file names, for the sake of simplicity, we will use DOS 8+3 format as an example for explanation here. One should of course realize that a longer file name would allow a larger Video Tree to be formed.

As mentioned above, a clip file is capable for self-running, i.e. self-executable. Traditional video files may be run by a software utility program, e.g. Windows Media Player®. This is in fact a software tool for handling the playback of a pre-defined video file format which contains video data and possibly some other information, e.g. the type of compression algorithm. In contradistinction, a self-executable clip file can self-run without such software utility programs. This can be achieved by embedding within the rough video data with a tiny executable program so that the video data can be self-run or self-executed.

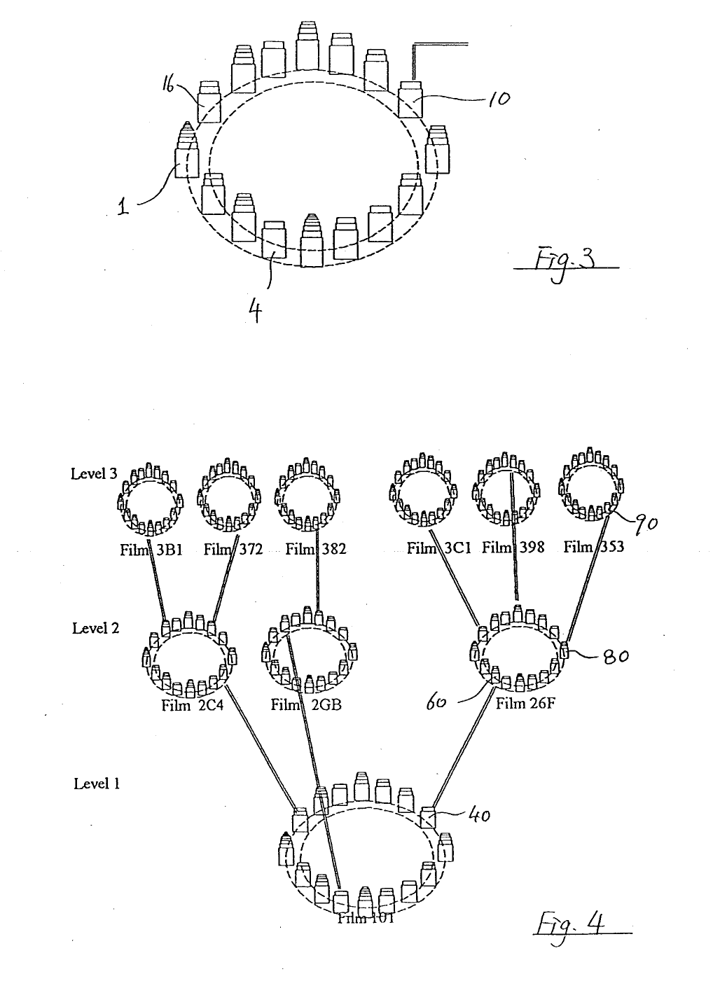

Clip files of a movie are arranged sequentially, say from 1 to N, where N is the number of the last scene of the whole movie, which is 16 in the example shown in FIG. 3. In this movie with 16 clip files, clip file 1 is of 10 seconds and shows scenes captured against a background in a school, clip file 4 is of 2 seconds and shows scenes captured against a background in a car park, and so on until the last clip file 16, which is of 3 seconds, which may show scenes captured against a background in a kitchen. In this movie, clip file 10 is of two seconds, and contains control header information which allows branching/switching to another clip file of another movie.

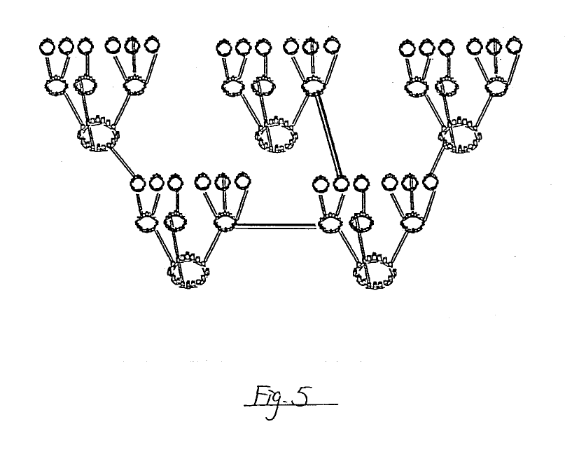

As shown in FIG. 4, a total of 10 movies are shown as linked with one another into a tree-like structure. While watching clip file 40 of Film 101 (of Level 1), a spectator may decide to branch/switch to clip file 60 of Film 26F (of Level 2), and then while watching clip file 80 of Film 26F, switch/branch to clip file 90 of Film 353 (of Level 3), and so on. The direction of branching may be reversed, e.g. from a film in Level 3, to one in Level 2, and then to one in Level 1, and then perhaps back to one in Level 2, and so on. A more sophisticated structure/network of movies arranged according to the present invention is shown in FIG. 5, containing a total of six levels of films.

In the playback mode, a clip file self-runs and links to the next clip file when it reaches its end scene. If there is no possible branching of the clip file, the next clip file in the same film will be played. On the other hand, after a branchable clip file is played back, and if the film to which it may be branched is available in the data storage, e.g. hard disk, video disc, or data server through the Internet, inquiries, e.g. text or voice messages, will be outputted to inquire of the spectator as to whether he/she decides to branch or not. If the response is in the affirmative, e.g. by pressing a “Branch Up” key/button or turning a jog dial in a first pre-defined direction of a machine, hereafter called “Video Tree Player”, adapted to reach and playback movies organized according to the present invention, the display screen of the monitor/television will dissolve gradually and take a while for setup before jumping to the related active clip file of the new film. If, on the other hand, the answer is in the negative, e.g. by pressing a “Branch Down” key/button or turning the jog dial of the Video Tree Player in a second pre-defined direction, the current film will keep on playing without taking any other action.

Such a branching is made possible by “decision node module” in the Video Tree Player, which not only monitors the progress of playing back of video movies, but also allows making of decision of branching through the Video Tree. This monitor program also keeps track with the video de-compression algorithm in the playback mode. When a new film is played, the database will be updated, which stores important information about the tree structure, allows it to expand and change in a dynamic mode of operation. In addition to the executable clip files, a monitor program tracks the whole process of the running of the clip files. It handles all the user interface, such as the pressing of buttons, turning of jog dials, branch up and branch down input from the user and performs the necessary action to divert or take branch action. In particular, whenever a user performs some actions, e.g. tries to switch film, the monitor program will check the current status during the film playback process, and also makes use of information stored in a “Dynamic Control Header” area to calculate a new file name for the next level or cross linkage branches. Whether the file is available in the storage device and web server or not, the program will activate the decision node to make the necessary decision and the decision node module will take the action accordingly, which may be switching of movies, checking availability of movies, etc.

All the hidden information together with any other important parameters for compression algorithm, available film status, dynamic branching, decision node, etc. are stored into an area called “Dynamic Control Header” information, and to be merged with the clip file or stored in the Video Tree operating system reserved area for future cross-linkage purpose.

One could imagine a huge number of clip files in the storage device. It is rather difficult for some existing operating systems, e.g. Microsoft® DOS, to handle a one-hour film with a minimum of 360 and a maximum of 3,600 clip files. One possible solution is to group all clip files of each movie into one or more files, so as to make the method compatible with existing computers with DOS or Windows® operating systems. For stand-alone Video Tree Players designed for running such self-executable clip files, other clip file formats may be adopted, as desired by the designer. One advantage of grouping clip files is the possibility of sharing of tiny executable programs among the clip files. Since these tiny executable programs occupy storage space, grouping helps minimize storage requirement and maximize play time.

One important feature of the present invention resides in the possibility of switching among movies. A linkage control protocol is thus established for allowing such branching/switching. Movies are grouped into files each with a file name and file extension. The format for clip files as discussed above could also apply in linkage control algorithm from movie to movie. The same principle also works in cases where a movie is split into several files. For simplicity, we assume here that one file holds one complete movie. As discussed above, a clip file is embedded with a tiny executable program for self-running. For a movie format formed of the collection of a number of clip files, such should also include at least one tiny executable program. The file extension will thus be “.exe” in DOS format. With this arrangement, and similar to the clip file monitor program discussed above, the linkage control protocol could be as simple as just creating another monitor program to track the process of user input for the branching action.

The numbering of a clip file determines where the movie is branched from, and the file name determines the movie to which the present movie is branched. On a one-level branch with 8-character file names, we have (36)⁸ (i.e. [26 alphabets+10 numerals] to the power 8) possible number of branches from one film to another. However, for multiple-level branches, we have to share these 8-character file names with the next or previous level of embedded information.

The total number and the spread of branches is a variable determined by the breadth and height, i.e. number of levels, of the Video Tree, and is also dependent on how the (36)⁸ numbers are to be arranged and assigned. It is clear that the longer the file name can be, the larger the cross-linkage and size of the Video Tree can be.

The first application of the method according to the present invention is for multiple movie playing. People enjoy interaction with the branch buttons or jog dial controls to change the principal actor. It is a breakthrough in the movie-making industry where each new movie will be embedded with an inter-linkage information in its clip files and each successive movie clip is linked with the existing network of movies to form a yet larger network of movies, with different beginnings and endings, depending on specific relationship with each others. The network of movies grows with special design in the Video Tree algorithm technique and the content linkage is stored on the hard disk drive. The more one plays with this new type of clip movies, the larger the network would become. The end result will be a miniature world of grand movies which people enjoy because of the many choices under his/her control.

The second possible application is “eTravelling” (electronic video map travelling). A single DVD may hold all the picture clip files of a specific place and allows people to navigate (travel) through the place, and view the actual moving pictures of that place. One can travel through the virtual map by operating the control buttons, say “Branch up” for stepping forward, “Branch down” for stepping backward, and “FF”, “REW” or rotation of the jog dial for changing direction. With this simple arrangement one can navigate through the electronic map and easily travel around in the virtual space.

The third application is for “ePicture” visual display system where a large amount of image files of various objects are stored and may be retrieved by using jog dial rotation to view the selected objects at different angles and “Branch up”/“Branch down” to select/deselect or make the buy decision in an “eShopping” environment. Product or object images are stored in Video Tree format and linked together to help user search and view contents easily. Each object is actually the picture image of one viewing direction of the object without background scene. The image can be caused to turn 360° around to allow the user to see the object in three-dimensional view.

By combining the above applications of “ePicture”, “eTravelling” and “eShopping” in the “Video Tree Player” environment, a complete virtual reality can be realized. Look at this scenario as one travels through the shopping arcade. One enters the shopping mall by “eTravelling”, presses the “Branch up” or “Branch down” button/key to step forward or backward, rotates the jog dial to turn direction and looks in a shop where different products are shown in “ePicture” and Video Tree format. One turns the jog dial to locate the active one and presses the “Branch up” button to select. One then turns the jog dial again to rotate the product for detailed examination in a more realistic three-dimensional view, then further presses the “Branch up” key to examine the exposed view by jumping to a higher tree level or drop the selected product to the shopping trolley.

Upon return to “eTravelling”, one again presses the “Branch up” or “Branch down” key to step forward or backward and continues with another venture. One comes to a DVD shop and looks for a new movie. One may search the films by playing demo films in virtual “Video Tree Player” and select the favorite film before completing the buying process.

It should be understood that the above only illustrate examples whereby the present invention may be carried out, and that various modifications and/or alterations may be made thereto without departing from the spirit of the invention.

It should also be understood that various features of the invention which are, for brevity, described here in the context of a single embodiment, may also be provided separately or in any appropriate sub-combinations.

What is claimed is:

1. A method of organizing at least a first movie and a second movie stored in a data storage media, wherein each said movie is stored in said data storage media in the form of a plurality of executable multimedia files, and wherein at least one executable multimedia file of said first movie includes machine-readable control information which, when read, directs an executable multimedia file of said second movie to be next executed.

2. A method according to claim 1 wherein the time for playing back each said executable multimedia file is less than a predetermined period of time.

3. A method according to claim 1 wherein at least one said executable multimedia file is configured to be self-executable.

4. A method according to claim 3 wherein said at least one executable multimedia file is incorporated with an executable program adapted to execute video contents in said executable multimedia file.

5. A method of playing back at least part of a first movie and at least part of a second movie stored in a data storage media, wherein each said movie is stored in said data storage media in the form of a plurality of executable multimedia files, including playing back at least one executable multimedia file of said first movie, reading control information of said at least one multimedia file of said first movie, and playing back at least one executable multimedia file of said second movie.

6. A method according to claim 5 wherein the time for playing back each said executable multimedia file is less than a pre-determined period of time.

7. A method according to claim 5 wherein at least one said executable multimedia file is configured to be self-executable.

8. A method according to claim 7 wherein said at least one executable multimedia file is incorporated with an executable program adapted to execute video contents in said executable multimedia file.

9. A data storage media stored with at least a first movie and a second movie each in the form of a respective plurality of executable multimedia files, wherein at least one executable multimedia file of said first movie includes machine-readable control information which, upon reading, directs an executable multimedia file of said second movie to be next executed.

10. A data storage media according to claim 9 wherein the time for playing back each said executable multimedia file is less than a pre-determined period of time.

11. A method according to claim 9 wherein at least one said executable multimedia file is configured to be self-executable.

12. A method according to claim 11 wherein said at least one executable multimedia file is incorporated with an executable program adapted to execute video contents in said executable multimedia file.
